(19) United States
(12) Patent Application Publication
(10) Pub. No.: US 2024/0406514 A1
(43) Pub. Date: Dec. 5, 2024

(54) FAULT-TOLERANT VIDEO STREAMING IN ONE-WAY TRANSFER SYSTEMS

(71) Applicant: Microsoft Technology Licensing, LLC, Redmond, WA (US)

(72) Inventor: Jeffrey Allen WEST, Woodinville, WA (US)

(73) Assignee: Microsoft Technology Licensing, LLC, Redmond, WA (US)

(21) Appl. No.: 18/326,434

(22) Filed: May 31, 2023

(51) Int. Cl. H04N 21/647; G02B 27/28; H04N 21/6408

(52) U.S. Cl. CPC H04N 21/64707; G02B 27/283; H04N 21/6408

(57) ABSTRACT

Methods and systems for method for video streaming in a one-way transfer (OWT) system. An example method includes transmitting, from a source computing environment, a video stream for receipt by a destination computing device in a destination computing environment. The video stream is duplicated into a primary video stream and a secondary video stream, both of which are received by a switching device. When the switching device detects an interruption in one of the duplicate data streams, the other stream is transmitted to the destination computing device.

### BACKGROUND

In data transfer and communications systems, communication may generally be performed in a two-way manner. For instance, two devices in communication with one another may exchange data in both directions. This ability allows for confirmations or acknowledgements that data has been received and processed correctly. In cases where the data is not received or processed correctly, such as due to dropped packets or corrupted data, the receiving device is able to request that the data be retransmitted. In systems where only one-way communication is implemented, no such acknowledgements or requests for the resending of data are available.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods relating to fault-tolerant video streaming in one-way transfer (OWT) systems. The OWT systems include components that restrict the flow of data in a single direction through the system while providing additional reliability enhancements to help ensure that the video stream is handled correctly and is tolerant to faults in the devices of the systems. For example, the system may include a transmitting computing device with an optical transmitter limited to transmit-only functions. The video stream is then optically transmitted through beam splitter to duplicate the video stream. The duplicated video streams may then pass through respective guards of a high-trust computing environment where the duplicated video streams are received by landing devices in the high-trust environment. The duplicated video streams are then switched or selected based on which video stream is being processed at a higher fidelity (e.g., fewer interruptions). This switching and deduplication may occur rapidly so that a live video stream remains continuously available and substantially uninterrupted to destination computing devices, such as display devices, in the high-trust computing environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIGS. 1A-B depict example one-way transfer (OWT) systems for fault-tolerant video streaming.

FIG. 2 depicts an example method for fault-tolerant video streaming in OWT systems.

FIG. 3 depicts another example method for fault-tolerant video streaming in OWT systems.

FIG. 4 is a block diagram illustrating example physical components of a computing device for practicing aspects of the disclosure.

### DETAILED DESCRIPTION

A one-way transfer system (OWT) refers to a computing system which uses one or more data diodes to ensure that data can be transferred only unidirectionally through the respective computing devices of the computing system. In examples, the data diodes ensure unidirectional data packet transfer through implementation of hardware and/or software components, such as a transmit-only network interface card (NIC).

OWT systems may be used to protect a network or endpoints against outbound data transmissions, malicious inbound data transmissions (e.g., viruses and malware), and cyberattacks. As one example, OWT systems facilitate the transfer of data between computing environments having the same or different security levels (e.g., high-security or low-security), where at least one of the computing environments is low trust with respect to another of the computing environments. For instance, a first computing environment that is high trust with respect to the devices of the first computing environment and/or with respect to devices of one or more other computing environments may receive data from a second computing environment that is considered to be low trust by the first computing environment.

In examples, a high-trust environment may be a system or network where the devices, applications, and users are considered trustworthy, and security measures are in place to establish and maintain that trust. In this type of environment, the devices and/or parties involved, such as devices, software, and users, are often authenticated, authorized, and/or adhere to established security policies and best practices. High-trust environments usually have rigorous access controls, encryption, and monitoring to ensure that trust is maintained and to minimize the risk of unauthorized access, data breaches, or other security incidents. Devices within high-trust environments may be authorized to access or be accessed by other devices based on security techniques that are implemented by the high-trust environments (e.g., unique encryption keys, secrets, or other cryptographical techniques). For instance, the communications transmitted by a high-trust environment may be considered trustworthy by other computing environments or devices based on the high-trust environment (or devices thereof) being included in an allowlist (e.g., a list of approved devices and/or computing environments). Alternatively, the communications transmitted by a high-trust environment may be considered trustworthy based on a password or credential provided with the communications. In some examples, the devices in a high-trust environment do not require authentication to access or be accessed by other devices. A high-trust environment generally does not expose the security techniques implemented by the high-trust environment to other computing environments, which may be considered low-trust or no-trust environments by the high-trust environment.

By contrast, a low-trust or no-trust environment may be a system or network where the devices, applications, and/or users are not implicitly trusted or where there's a high risk of unauthorized access or malicious activities. This type of environment might have limited or no security measures in place, or the environment may be one where a high number of external or unmanaged devices are connected Alternatively or additionally, a low-trust or no-trust environment refers to an environment in which the devices are not considered to be secured or trustworthy by other devices within and/or external to the low-trust or no-trust environments. As the security techniques implemented by the high-trust environment are not exposed to low-trust or no-trust environments, low-trust or no-trust environments may not be able to access or communicate with a high-trust environment without performing various authorization and/or authentication steps that need not be performed by devices in high-trust environments.

Due to the unidirectional data transmission of OWT system, there is no confirmation that data sent over the unidirectional transmission line has been received by the receiving device and/or processed correctly by the receiving device. In contrast, in bi-directional systems, communication protocols such as the Transmission Control Protocol (TCP) may be used where confirmations can be sent back to the transmitting device. For example, with TCP, when a connection is established between two devices, the two devices exchange a series of messages to synchronize and establish the connection parameters. Then, when the transmitting device sends data, the receiving device returns an acknowledgment (ACK) message back to the transmitting device to confirm that it has received the data. If the transmitting device does not receive an ACK within a certain amount of time, the transmitting device will resend the data. With OWT systems, no such ACK messages are possible because communications cannot be sent back to the transmitting device from the receiving device. As a result, there must be robust systems in place to help ensure that the data transmitted from the transmitting device is actually received and properly handled by the receiving device. If no such systems are in place, the reliability of the system would be significantly reduced.

The present technology introduces such robust systems that are tolerant to faults within the receiving device to better ensure that video streams received from the transmitting device are properly handled. For example, the system may include a transmitting computing device that receives video streams from video-source devices, such as cameras or other devices that generate video streams. The transmitting device then causes the received video streams to be duplicated. For instance, the transmitting device may have an optical transmitter limited to transmit-only functions. The video stream is then optically transmitted through a beam splitter that divides or duplicates the optical signal. The divided or duplicated optical signal from the beam splitter is provided to at least two receiving devices (e.g., guards) that provide entry points to another computing environment, which may be a high-trust computing environment. The guards inspect the video streams to assure policy compliance and security validations of the high-trust environment.

The video streams passed from each of the receiving devices (e.g., guards) are further received by two landing devices in the high-trust computing environment. The duplicate video streams are then deduplicated by the landing devices, or by another deduplication device, to ensure that both of the duplicate video streams do not reach a display of high-side computing device that is requesting the respective video stream. Selection and deduplication of the video streams is done in both a reliable and extremely quick manner to allow for a single live stream to be provided to high-side computing devices in a way that is tolerant to faults occurring in the OWT system. For instance, switching between the duplicate streams may be performed in less than 100 milliseconds (ms).

To facilitate the switching, performance data of the two landing devices is analyzed to determine which of the landing devices is processing the video stream properly or in the best manner. Ine examples, such performance data includes data about the landing devices themselves and/or data regarding the video streams being handled by the landing devices, such as continuity counter data of the video stream. The live video stream may then be provided from the landing device that is performing best (e.g., providing the highest fidelity video stream). In the case that one landing device degrades in performance, the live stream that is output to the high-side device is quickly switched to the other duplicate stream. Thus, even where there is a fault in one of the receiving devices (e.g., guards) and/or landing devices, another device ensures that the video stream is still handled and transmitted further through the system with little to no delay or loss.

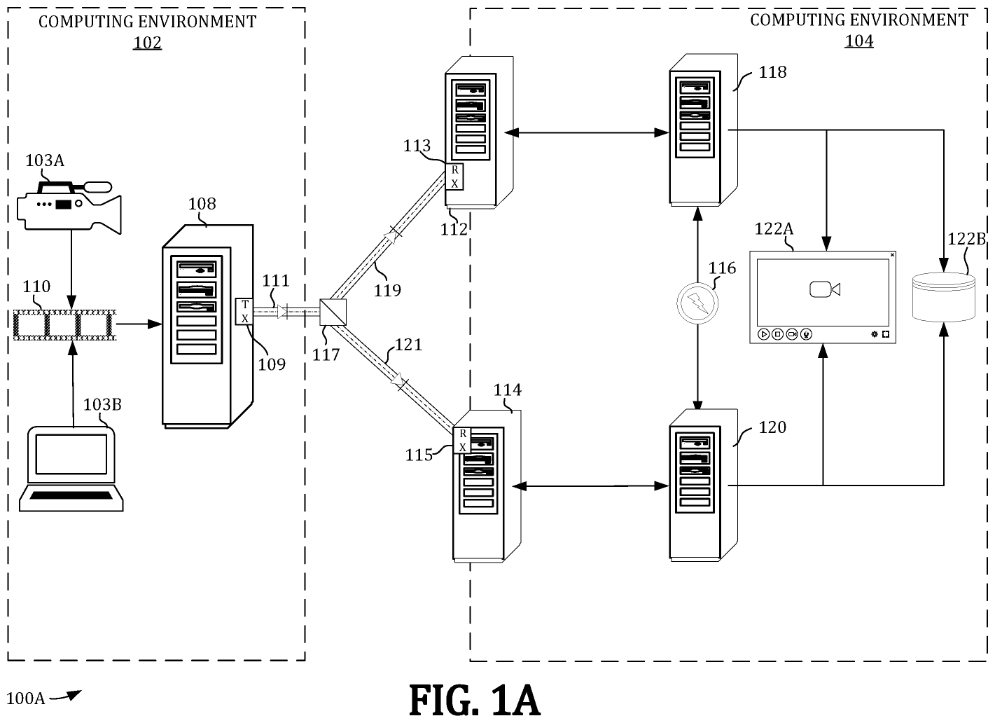

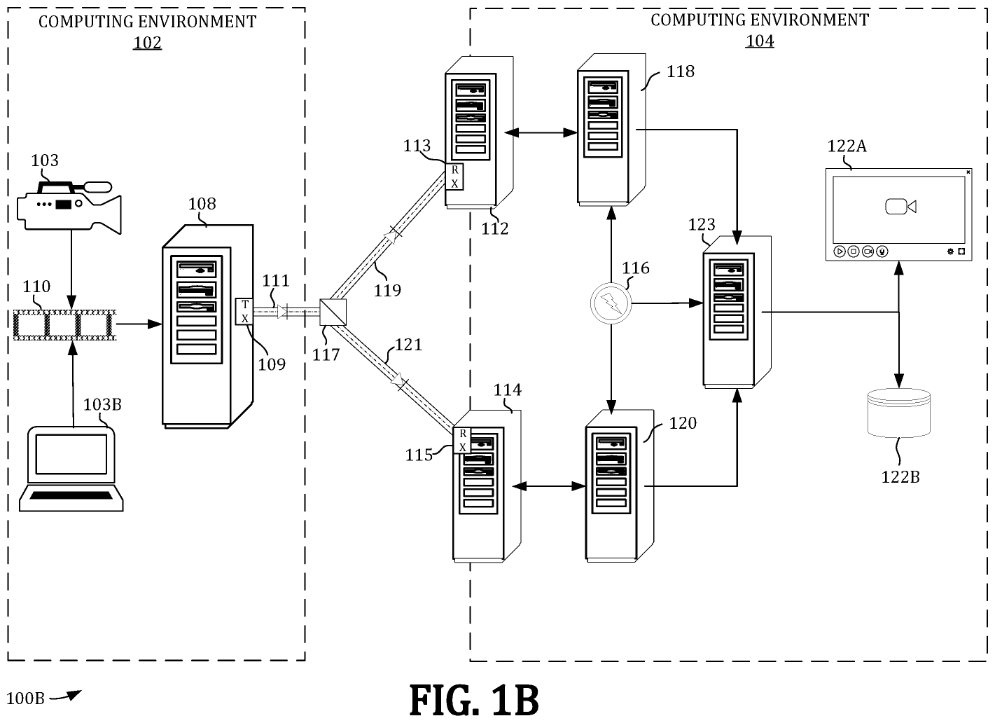

FIG. 1A depicts an example one-way transfer (OWT) system 100A for fault-tolerant video streaming. System 100A, as presented, is a combination of interdependent components that interact to form an integrated whole. Components of system 100A may be hardware components or software components (e.g., application programming interfaces (APIs), modules, runtime libraries) implemented on and/or executed by hardware components of system 100A. In one example, components of system 100A are distributed across multiple processing devices or computing systems.

System 100A represents an OWT system for transmitting data between different computing environments. System 100A includes a first computing environment 102 and a second computing environment 104. In some examples, computing environments 102, 104 are implemented in a cloud computing environment or another type of distributed computing environment and are subject to one or more distributed computing models/services (e.g., Infrastructure as a Service (IaaS), Platform as a Service (PaaS), Software as a Service (SaaS), Functions as a Service (FaaS)). In some examples, each environment is a separate network or sub-network. Although FIG. 1A is depicted as including a particular combination of computing environments and devices, the scale and structure of devices and computing environments described herein may vary and may include additional or fewer components than those described in FIG. 1A. Further, although examples presented herein will be described in the context of OWT systems and data transfers between low-trust computing environments and high-trust computing environments, the examples are also applicable to other types of data transfers between computing environments of various (or the same) types and security levels. For instance, the first environment 101 may also be referred to as a source environment and the second environment 101 may be referred to as a destination environment.

In examples, the first computing environment 102 represents a source, or low-trust, computing environment in which devices executing within computing environment 102 are not trusted by devices executing within the second computing environment 104. In such examples, the first computing environment 102 may be physically separated from the second computing environment 104 such that the first computing environment 102 is in a first physical location (e.g., region, building, room, and/or server rack) and computing environment 104 is in one or more other physical locations. Alternatively, the computing environments 102, 104 may all be located in the same physical location.

In the example depicted, the first computing environment 102 includes a computing device 108. The computing device 108 may be referred to herein as the low-side computing device 108 or the transmitting device 108. The low-side computing device 108 receives one or more video streams 110 that is captured by a source device 130, such camera 103A or source computing device 103B. The source device 130 is within, or accessible to, the first computing environment 102. The camera 103A may be any type of camera capable of capturing and streaming video data, such as drone cameras, security cameras, body-worn cameras, etc. The source computing device 103B may be a computing device that is capable of generating a video stream, such as a screen share, video conference, computer-generated video, etc. Video stream 110 may be in a variety of types of video stream data such as the Moving Picture Experts Group (MPEG)-Transport Stream (TS) format.

In examples, the low-side computing device 108 serializes the video stream 110 by separating the data or video stream 110 into one or more data chunks using a file segmentation service or utility, which may be implemented locally on computing device 108 or accessed remotely by computing device 108. The low-side computing device 108 may also enrich the video stream with additional data, such as routing data. The additional data may include a unique identifier, such as a globally unique identifier (GUID), for the video stream. The unique identifier may then be used in the deduplication process discussed below.

The segmented data of the video stream 110 is then transmitted (e.g., optically) one way to the second computing environment 104, which may be a higher-trust computing environment with respect to the first computing environment 102. The second computing environment 104 includes computing device 112 and computing device 114. In some examples, computing devices 112 and 114 are located proximate the computing device 108 (e.g., in the same building or room). For instance, computing devices 112, 114 and computing device 108 may be located in the same room of a data center such that computing device 108 is located in a first data rack (e.g., server rack or data cabinet), and the computing devices 112, 114 are located in a second data rack or a different shelf of the first data rack. In such examples, the computing device 108 and the computing devices 112, 114 may be directly connected via point-to-point cabling, which may be optical as discussed further herein.

In some examples, the computing device 112 and the computing device 114 are physically separated from one another to help ensure reliability and redundancy. For instance, the computing device 112 and the computing device 114 may be in different server racks or different rooms that rely on different power supplies. Accordingly, if power is lost for the computing device 112, power may still remain for the second computing device 114. In other examples, computing devices 112, 114 are located remotely from computing device 108 (e.g., in a different building or room).

The computing devices 112, 114 receive the data that is transmitted from the low-side computing device 108. Thus, in some examples, the computing device 112 may be referred to herein as a first receiving device 112, and the computing device 114 may be referred to herein as a second receiving device 114. The receiving devices 112, 114 may also operate as guards, and computing devices 112, 114 may otherwise be referred to as the first guard 112 and the second guard 114 or cross-domain protection devices 112, 114. The guards 112, 114 protect the second computing environment 104 from data entering the second computing environment 104 from the first computing environment 102. The guards 112, 114 may perform changes and/or checks to the video stream received from the transmitting device 108. In some examples, the guards 112, 114 transcode the video stream and/or ensure that certain information is encoded in a portion of the video stream, such as key-length-value (KLV) data in an MPEG-TS data stream. Alternatively or additionally, the guards 112, 114 may perform security checks or policy enforcement on the video stream to remove malicious data or remove any other types of data according to a policy set by the administrator of the second computing environment 104. If the video stream meets the criteria set forth by the guards 112, 114, the guards 112, 114 further transmit the video streams to respective landing devices 118, 120 the third computing environment 106.

Returning to the transmission of data between the low-side computing device 108 and the guards 112, 114, the unidirectional transfer of data from the low-side computing device 108 to the computing devices 112, 114 may be accomplished optically. The use of optical transmission may add additional speed, reliability, and/or security to the data transfer. In the example depicted, the low-side computing device 108 includes an optical transmitter 109 that converts the segmented data of the video stream 110 into an optical signal that is transmitted into a first optical fiber 111. For instance, the optical transmitter 109 may encode the segmented data of the video stream 110 into a series of light pulses.

In general, fiber optic communication is a method of transmitting information from one location to another using light signals transmitted through optical fibers. Optical fibers are generally thin strands of glass or plastic that are designed to guide light along their length. Optical fibers provide many advantages including high speeds and the ability to transmit data with very little loss of signal strength. In addition, fiber optic communication is more secure than other forms of communication because it is difficult to intercept and tamper with the signals transmitted through optical fibers.

The optical transmitter 109 may be part of a transmit-only NIC or other circuit board that includes transmission-only capabilities. For instance, the circuit board may have no capability to receive optical data. In other examples, if the circuit board does include an optical receiver, no optical fiber from either of the guards 112, 114 is connected to the receiver, and thus no data can be received by the optical receiver. For instance, a transmit-only NIC transmits data to an endpoint but cannot receive data from the endpoint due to the physical severing of the receive pin on the network controller chip of the transmit-only NIC. In some examples, the transmit-only NIC may also include firmware which sets the link state of the transmit-only NIC to always be “up” (e.g., enabled and/or active). In still other examples, a transmit-only circuit is formed by attaching a splitter cable (e.g., y-splitter cable), where the transmission signal is split into two cables and one of the cables is directed back to the optical receiver of the transmitter circuit, which establishes a layer-1 link state and causes the circuit to sense a return data path even though no return data path actually exists. In yet other examples, a field-programmable gate array (FPGA) or similar device may be configured to restrict data flow to be only unidirectional (e.g., transmit-only). Where the one-way communication is required by the physical components (rather than software-defined constraints), the one-way communication is considered to be physically enforced.

The optical signal generated from the optical transmitter 109 is then split by a beam splitter 117. The beam splitter 117 splits the optical signal (e.g., splits the light transmitted through the first optical fiber 111) into multiple optical signals. In the example depicted, the optical signal is split into two divided optical signals. One of the divided optical signals is passed into a first receiving optical fiber 119, and the other divided optical signal is passed into a second receiving optical fiber 121. Each of the divided optical signals replicate the original optical signal and therefore include the sample data as the original optical signal. While the optical signal is split into two optical signals in this example, the light may be split into additional signals in different examples.

The beam splitter 117 may be a passive splitter that does not require electrical power. For instance, when the light enters the beam splitter 117 from the first optical fiber 111, the light is split into the first receiving optical fiber 119 and the second receiving optical fiber 121 without the need for additional power. The passive beam splitter 117 utilizes reflective and/or refractive properties of its materials to cause the light to be split, such as by using two glass prisms that are adhered or otherwise connected to one another to create a partially reflective surface, a half-silvered mirror, a dichroic mirrored prism, or other suitable designs for splitting a beam of light.

By utilizing a passive beam splitter 117, additional reliability is also introduced into the system because the passive beam splitter 117 requires no power to operate. In other examples, however, an active or powered beam splitter 117 is utilized. In some examples, the beam splitter 117 is positioned within the first computing environment 102 or the second computing environment 104. For instance, the beam splitter 117 may be a part of the low-side computing device 108 and/or part of the optical transmitter 109. In other examples, the beam splitter 117 is positioned in the second computing environment 104. For example, the beam splitter 117 may be incorporated into the guard 112, the second guard 114, and/or another device of the second computing environment 104.

While the beam splitter 117 is primarily discussed herein as being a passive beam splitter, the beam splitter 117 may include other devices that split and/or duplicate the optical signals, and the beam splitter 117 may also be powered in some examples. For instance, the beam splitter 117 may include a switch with a Switched Port Analyzer (SPAN) port. the SPAN port creates a copy or duplicate of the data that can then be sent to another destination. As a result, a SPAN port may also be referred to as a mirror port in some examples. The duplicate is created by monitoring a source port and duplicating the data that is received on the source port. The beam splitter 117 may also be in the form of a Test Access Point (TAP). A TAP is a passive hardware device that splits or copies the data via beam splitter or passive optical coupler that splits the optical signals into two separate paths.

The divided optical signals are then received by the first guard 112 and the second guard 114 in parallel, respectively. More specifically, the divided optical signal propagating through the first receiving optical fiber 119 is received by a first optical receiver 113 of the first guard 112 that is coupled to the first receiving optical fiber 119. The divided optical signal propagating through the second receiving optical fiber 121 is received by a second optical receiver 115 of the second guard 114 coupled to the second receiving optical fiber 121. The optical receivers 113, 115 convert the optical signal into an electrical data signal that is the substantially the same as the electrical signal representing the segmented data of the video stream 110 that was provided to the optical transmitter 109. The electrical data signal representing the segmented data of the video stream 110 may then be processed by the first guard 112 and the second guard 114 as discussed herein. Effectively, duplicate video streams are thus received by the guards 112, 114.

If the first guard 112 determines that the video stream 110 meets the requirements of the second computing environment 104 (as discussed above), the first guard 112 transcodes and transmits the video stream to the first landing device 118. Similarly, if the second guard 114 determines that the video stream meets the requirements of the second computing environment, the second guard 114 transcodes and transmits the video stream to the second landing device 120. Accordingly, if both guards 112, 114 are functioning properly and transmit the video stream 110, the landing devices 118, 120 receive duplicate video streams 110.

Because the video stream 110 that is transmitted from the first computing environment 102 to the second computing environment 104 is done so in a unidirectional manner, no acknowledgements, or requests for video stream (or portions thereof) to be resent, can be transmitted back to the first computing environment 102 from the second computing environment 104. For example, if the first guard 112 or the first landing device 118 were to stop operating (e.g., system crash, power loss), the low-side computing device 108 would have no way of determining devices are no longer functioning correctly. To help ensure that video stream received by the second computing environment 104 is handled and processed with a high fidelity, the second guard 114 and the second landing device 120 provide data redundancy to the first guard 112 and the first landing device 118 for the video stream 110 that is transferred from the first computing environment 102 to the second computing environment 104. Thus, even if one of the guard 112 or the second guard 114 (and/or the first landing device 118 or the second landing device 120) becomes inoperable, the other device is still able to process the video stream 110.

To provide such data redundancy, the first landing device 118 and the second landing device 120 may be in communication with one another, which may be bidirectional communication (e.g., TCP) or unidirectional communication depending on the implementation. One type of data that may be communicated is referred to as performance data 116.

The performance data 116 may indicate the performance and/or status of the particular device from which it was sent and/or data about the video stream that is being processed. For example, performance data 116 from the first landing device 118 indicates the status or performance of the first landing device 118. Performance data 116 from the second landing device 120 indicates the status or performance of the second landing device 120. In some examples, the performance data 116 also provides status data about the respective guards. For instance, the performance data 116 from the first landing device 118 may also indicate operating status data of the first guard 112. The performance data 116 may also include operating status data of the second guard 114. Thus, based on the status data 116, each of the first landing device 118 and the second landing device 120 is able to determine if the other device is functioning properly.

The first landing device 118 and/or the second landing device 120 may use the performance data 116 to change its operating state and determine which of the first landing device 118 or the second landing device 120 is the source of the video stream 110 for the high-side destination computing device 122, which may be a device such as a display device 122A to display the video stream and/or a storage device 122B to store the video stream. Other types of destination devices 122 may also be possible, such as devices that process and/or analyze the video stream that is received. For instance, either the first landing device 118 or the second landing device 120 transmits the video stream 110 to the destination device 122, but not both of the landing devices 118, 120.

In some examples, the performance data 116 includes information such as uptime, processing speed, bandwidth utilization, etc. Alternatively or additionally, the performance data 116 may include transmission information for one or more time periods. Examples of transmission information include the quantity of data transmitted during the time period, a list of data chunks, data segments, or packets transmitted for the video stream, data transmission metrics (e.g., average/maximum time to transfer video stream packets), the number of packets lost during transmission, and the current role or operating state of the computing device (e.g., primary device or secondary device).

The performance data 116 may also include data specific to the video stream 110 that is being processed by the first landing device 118 and the second landing device 120. For example, the performance data 116 may include data based on a continuity counter for the video stream 110. A continuity counter is a mechanism used in video streaming to ensure the correct ordering and consistency of data packets as they are transmitted across a network. For instance, one example of a continuity counter may be used with the MPEG-TS format.

For video streams in the MPEG-TS format, a continuity counter is a 4-bit field in the header of each Transport Stream Packet (TSP). The counter is incremented by 1 for each successive packet that carries a payload belonging to the same Packetized Elementary Stream (PES), which represents a single video, audio, or data stream within the transport stream. The continuity counter provides a way to identify and manage packet loss, duplication, or reordering that may occur during transmission. In some examples, the counter is incremented between 1-16 and then reset to 1 for the following packet. In the present technology, the first landing device 118 and the second landing device 120 may also create a secondary counter that indicates which set of continuity counters is being received. The first set of 16 counts/packets may then be distinguished from the second set (and other subsequent sets) of 16 counts/packets.

As some additional detail, when the video stream 110 is initially encoded in the first computing environment 104, the video stream 110 is broken down into smaller chunks and encapsulated into Transport Stream Packets (TSPs) for transmission. Each TSP has a header that contains information about the packet, such as the Packet Identifier (PID) that uniquely identifies the PES to which the packet belongs and the continuity counter that tracks the packet sequence within the PES. As packets are transmitted, the continuity counter in the TSP header is incremented for each successive packet belonging to the same PES.

Each of the first landing device 118 and the second landing device 120 may check the continuity counter of each received TSP. If the counter values are in the expected sequence, the first landing device 118 and the second landing device 120 may assume that the packets have arrived in the correct order without loss or duplication. If the continuity counter values are out of sequence, the first landing device 118 and the second landing device 120 may detect packet loss, duplication, or reordering.

The result of the analysis of the continuity counter by the first landing device 118 and/or the second landing device 120 may be included in the performance data 116. In some examples, the continuity counter of each packet processed by the first landing device 118 and/or the second landing device 120 is included in the performance data 116. For instance, when the first landing device 118 processes a particular packet, the performance data 116 may indicate the continuity counter value for the packet an indicator that the packet was processed by the first landing device 118.

In some examples, the first landing device 118 and the second landing device 120 operate as either a primary device or a secondary device. The primary device transmits the video stream 110 further through the system, such as to a high-side destination device 122. The secondary device does not transmit the received data further through the system. For instance, the secondary device may ultimately drop (e.g., delete or discard) the video stream data it has received. In other examples, the secondary device may store a copy of the video stream 112 for backup or restoration purposes.

The designation of whether the first landing device 118 or the second landing device 120 is the primary device or the secondary device depends on the performance data 116. In some examples, one of the landing devices 118, 120 is designated as the primary device for all incoming video streams until that status data 116 indicates that the primary device is no longer functioning properly. For example, the first landing device 118 may be initially designated as the primary device, and the second landing device 120 may be designated as the secondary device.

In such examples, the first landing device 118 retains its primary device operating status until the second landing device 120 is no longer functioning or is no longer functioning correctly. Criteria for determining whether the first landing device 118 is functioning correctly may be based on the performance metrics of the first landing device 118, which may be represented in the performance data 116. For instance, the health data and/or transmission information may be compared to one or more thresholds to determine if the first landing device 118 is functioning properly or within acceptable limits. If no performance data 116 is received (e.g., due to the first landing device 118 being down), the performance data 116 may be considered outside of the threshold and therefore indicate the non-functionality of the first guard 112. Such a determination may be made by the second landing device 120 based on the performance data 116 that is received from the first landing device 118. Additionally or alternatively, if the first landing device 118 does not receive performance data 116 from the first landing device 118 from within a timeout period (e.g., a set duration), the second landing device 120 determines that the first landing device 118 is not functioning properly.

When the second landing device 120 determines that the first landing device 118 is not functioning properly based on the performance data 116 (or lack thereof), the second landing device 120 changes its operating state from the secondary device to the primary device and becomes the source for the video stream 110 to subsequent devices, such as the destination device 122. If the first landing device 118 is still partially operational, the second landing device 120 may indicate the operating state change to the first guard 112 as part of the performance data 116. When the second landing device 120 is operating as the primary device, the landing device 120 transmits the video stream further through the system (e.g., to destination device 122), and the first landing device 118 does not further transmit the data.

While the second landing device 120 is operating as the primary device, the second landing device 120 may continue to transmit performance data 116 to the first landing device 118. In examples where the first landing device 118 is still operating (but at a degraded performance), the first landing device 118 may also continue transmitting the performance data 116 to the second landing device 120. In some examples, the second landing device 120 continues to operate as the primary device even where the first landing device 118 regains its proper or acceptable performance (as indicated by the performance data 116). In such examples, the first landing device 118 may transition back to the primary device when the performance data 116 indicates that the second landing device 120 is no longer functioning properly. The determination that the second landing device 120 is not functioning properly may be similar to the determination relating to proper functioning of the first landing device 118 discussed above. For instance, the first landing device 118 may compare the performance data 116 from the second landing device 120 to one or more thresholds to determine if the second landing device 120 is functioning properly.

In other examples, the second landing device 120 may revert to the secondary device upon detecting that the first landing device 118 has regained functionality. The first landing device 118 then resumes its operating state as the primary device. For example, based on the performance data 116, the second landing device 120 may determine that the first landing device 118 has resumed proper functionality. The second landing device 120 may then transmit a message (e.g., as part of the performance data 116) that indicates the first landing device 118 is to resume operating as the primary device and the second landing device 120 is switching its operating state to the secondary device.

The switching of operating states may occur rapidly, and in some examples, the switching may occur within less than 100 milliseconds (ms). In some examples, the switching occurs on a packet-by-packet basis. For instance, if the second landing device 120 is operating as a secondary device and receives a particular TS packet having a particular continuity count value and the performance data 116 indicates that the first landing device 118 did not process that particular packet, the second landing device 120 transmits the particular packet. The transmission of the particular packet may then be indicated in the performance data 116. The first landing device 118 may retain operating status as the primary device for subsequent packets or the second landing device 120 may switch to the primary device for subsequent packets until there is another packet that is processed by one landing device but not the other.

FIG. 1B depicts another example system 100B that includes a de-duplication or switching device 123 in the second computing environment 104. Other than the inclusion of the de-duplication or switching device 123 and the related functions discussed below, the system 100B may be substantially similar to system 100A discussed above.

In system 100B, the performance data 116 from the first landing device 118 and the second landing device 120 may be provided to the switching device 123 along with the video streams from the first landing device 118 and the second landing device 120. The switching device 123 may then rapidly switch between the video streams 110 coming from the first landing device 118 and the second landing device 120 based on the performance data 116 and/or the video streams themselves. A single video stream 110 is then provided to the destination device 122 from the switching device 123.

The switching device 123 may effectively treat the duplicate video streams 110 coming from the first landing device 118 and the second landing device 120 as a primary video stream and a secondary video stream. The primary video stream is provided to the destination device 122 until an interruption to the primary data stream is detected. When the interruption is detected, the secondary stream is then transmitted to the destination device. In some examples, the primary video stream may be the video stream 110 from the first landing device 118, and the secondary video stream may be the video stream from the second landing device 120.

An interruption in the primary video stream may be based on the continuity counter of the video stream and/or of the from performance data 116. For instance, when an expected packet of the video stream 110 is not received as part of the primary video stream, the switching device 123 may rapidly switch to the secondary video stream and provide the secondary video stream to the destination device 122. The switching device 123 may continue to provide the secondary video stream to the destination device 122 until an interruption in the secondary video stream is detected by the switching device 123. When the interruption in the secondary video stream is detected, the switching device 123 may then switch back to the primary video stream. Because the switching device 123 is concurrently receiving the primary and secondary video streams, the switching device 123 may switch to the video stream that has the least interruptions or generally least frequent number of dropped packets. The switching between the primary video stream and the secondary video stream may be performed rapidly (e.g., 100 ms or less). For instance, switching may occur on a packet-by-packet basis.

The switching between the primary video stream and the secondary video stream may also be based on the performance data 116, such as health data of the first landing device 118 or the second landing device 120. For instance, if the performance data 116 indicates a performance degradation of the first landing device 118, the switching device 123 may switch to the secondary video stream even where the primary video stream has not yet encountered any interruptions.

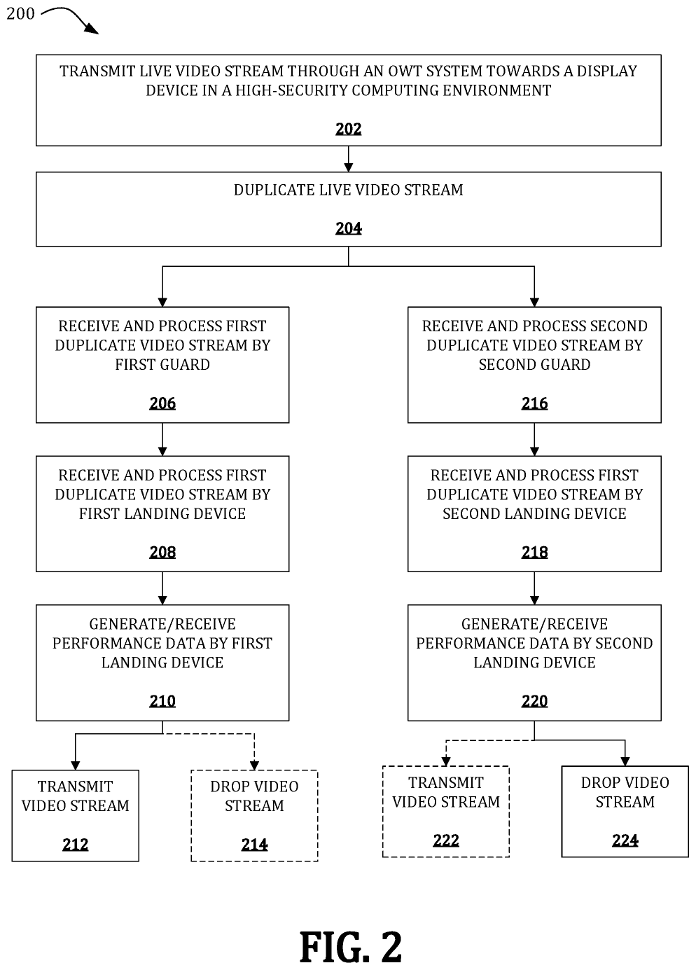

FIG. 2 depicts an example method 200 for providing live video streaming in OWT systems. The method 200 be performed by one or more of the devices discussed above, such as the devices within systems 100A-B.

At operation 202, a live video stream is transmitted from a transmitting device or low-side device towards a destination device in a high-trust environment. For instance, the low-side device may receive the live video stream from a camera that is connected to the Internet or similar low-trust or untrusted network. At operation 204, the video stream is duplicated into a first duplicate video stream and a second duplicate video stream. As an example, the video stream may be converted into an optical signal that is duplicated through the use of beam splitter.

At operation 206, the first duplicate video stream is received and processed by a first guard. If the first duplicate video stream meets the evaluation criteria of the first guard, the first duplicate video stream is transmitted to a first landing device on a high-trust computing environment that is protected by the first and second guard. At operation 208, the first landing device receives and processes the first duplicate video stream from the first guard.

At operation 216, the second duplicate video stream is received and processed by the second guard. If the second duplicate video stream meets the evaluation criteria of the second guard, the second duplicate video stream is transmitted to a second landing device in the high-trust computing environment. At operation 218, the second landing device receives and processes the second duplicate video stream from the second guard.

As the landing devices are processing the packets of the video streams, the landing devices also generate performance data and exchange the performance data with the other landing devices. For example, at operation 210, the first landing device generates first performance data about its own performance and processing of the video stream. The first landing device also receives second performance data generated by the second landing device. Similarly, at operation 220, the second landing device generates the second performance data about its own performance and processing of the video stream. The second landing device also receives the performance data generated by the first landing device.

Based on the performance data, the first landing device or the second landing device then transmits the video stream to the destination device in the high-trust computing environment. For instance, if the performance data indicates that the first landing device is operating properly, the first landing device transmits the video stream to the destination device at operation 212 and the second landing device may drop the video stream at operation 224. If, however, the performance data indicates that the first landing device is not functioning properly, the second landing device transmits the video stream to the destination device in operation 222 and the first landing device drops the video stream at operation 214.

The determination of whether the first landing device and/or the second landing device is functioning properly may be based on comparing the performance data to one or more thresholds. If the performance data is outside of the threshold for the particular device, that particular device may be considered to not be functioning correctly. In addition, indications of missed packets in the video stream based on the continuity counter data may also demonstrate that the corresponding device is not functioning properly (or is functioning worse than another device).

The method 200 may then continue or repeat for as long as the live video stream continues to be generated and/or captured by the camera or other video generating device. As such, switching between the first landing device and the second landing device may occur multiple times over the duration of the video stream.

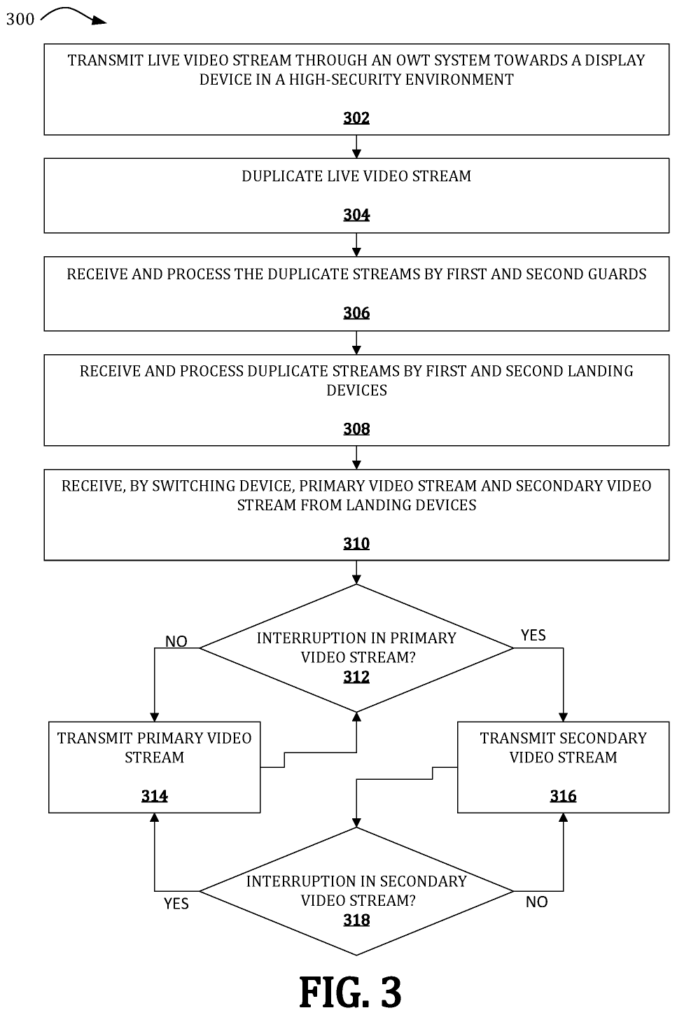

FIG. 3 depicts another example method 300 for providing live video streaming in OWT systems. The method 300 may be performed by one or more of the devices discussed above, such as the devices within systems 100A-B.

At operation 302, a live video stream is transmitted from a transmitting device or low-side device towards a destination device in a high-trust environment. For instance, the low-side device may receive the live video stream from a camera that is connected to the Internet or similar low-trust or untrusted network. The video stream may also be enriched by the transmitting device to add additional data to the video stream, such as routing data. For instance, the transmitting device may add an identifier (e.g., GUID) to the video stream that identifies that particular video stream. At operation 304, the video stream is duplicated into a primary video stream and a secondary video stream. As an example, the video stream may be converted into an optical signal that is duplicated through the use of beam splitter.

At operation 306, the duplicate video streams are received and processed by a first guard and a second guard. At operation 308, the duplicate video streams from the first and second guards are received by first and second landing devices, respectively. At operation 310, a switching device receives the primary video stream from the first landing device and the secondary video stream from the second landing device. In examples where the switching device receives multiple video streams, the switching device may identify a particular video stream as a duplicate of another based on the unique identifier (e.g., GUID) added to the video stream by the low-side transmitting device.

At decision 312, a determination is made by the switching device as to whether there is an interruption in the primary video stream (e.g., one or more packets dropped or missing) and/or a quality of the primary video stream has degraded below a threshold level. If there is not an interruption or drop in quality in the primary video stream, the method 300 flows to operation 314 where the primary video stream is transmitted from the switching device to the destination device in the high-trust environment. The primary video stream is transmitted without transmitting the secondary video stream. For example, either the primary video stream or the secondary video stream is transmitted from the switching device, but not both. The method 300 then flows back to decision 312 to reevaluate if interruptions are occurring in the primary video stream.

If at decision 312 an interruption and/or drop in quality in the primary video stream is identified or determined, the method 300 flows to operation 316 where the secondary video stream is transmitted from the switching device to the destination device (instead of the primary video stream). As the secondary video stream is being transmitted, the method 300 flows to operation 318 where a determination is made as to whether there are any interruptions and/or reductions in quality in the secondary video stream. If there are not interruptions or drops in quality in the secondary video stream, the method flows back to operation 316 where the secondary video stream continues to be transmitted. If, however, there is an interruption and/or a drop in quality in the secondary video stream, the method flows to operation 314 where the primary video stream is transmitted from the switching device to the destination device instead of the secondary video stream.

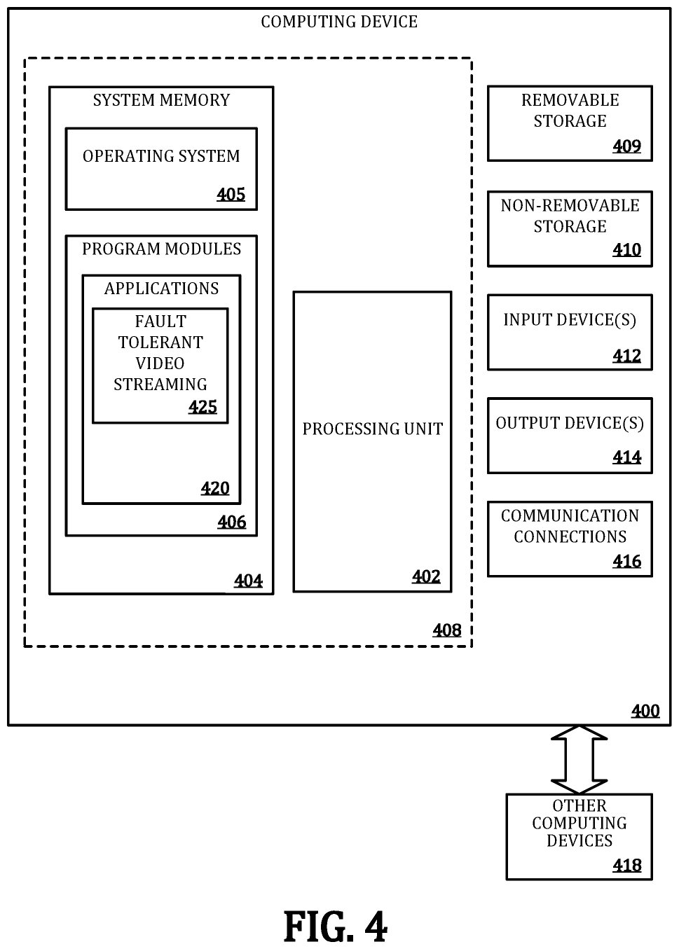

FIG. 4 is a block diagram illustrating physical components (e.g., hardware) of a computing device 400 with which aspects of the disclosure may be practiced. The computing device components described below may be suitable for the computing devices and systems described above, such as the transmitting computing device, guards, landing devices, switching device, destination device, etc. In a basic configuration, the computing device 400 includes at least one processing unit 402 and a system memory 404. Depending on the configuration and type of computing device, the system memory 404 may comprise volatile storage (e.g., random access memory (RAM)), non-volatile storage (e.g., read-only memory (ROM)), flash memory, or any combination of such memories.

The system memory 404 includes an operating system 405 and one or more program modules 406 suitable for running software applications 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, or optical disks. Such additional storage is illustrated in FIG. 4 by a removable storage device 409 and a non-removable storage device 410.

As stated above, a number of program modules and data files may be stored in the system memory 404. While executing on the processing unit(s) 402, the program modules 406 (e.g., applications 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc. For instance, the applications 420 may include a video streaming application 425 that performs the operations discussed herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

As should be appreciated from the forgoing discussion, in an aspect, the technology relates to a method for video streaming in a one-way transfer (OWT) system. The method includes transmitting, by a transmitting device in a source computing environment, a video stream for receipt by a destination computing device in a destination computing environment; forming a primary video stream and a secondary video stream by duplicating the video stream; receiving, by a switching device in the destination computing environment, both the primary video stream and the secondary video stream; transmitting, by the switching device, the primary video stream to the destination computing device without transmitting the secondary video stream; detecting, by the switching device, an interruption or change of quality in the primary video stream; and based on detecting the interruption or change of quality, transmitting, by the switching device, the secondary video stream to the destination computing device instead of the primary video stream.

In an example, duplicating the video stream is achieved by splitting an optical signal representing the video stream. In another example, detecting the interruption in the primary video stream is based on continuity counter data for the video stream. In a further example, the video stream is in a Moving Picture Experts Group (MPEG)-Transport Stream (TS) format. In another example, the method further includes receiving, by a first landing device in the destination computing environment, the primary video stream; receiving, by a second landing device in the destination computing environment, the secondary video stream; and wherein detecting the interruption in the primary video stream is based on performance data received from at least one of the first landing device or the second landing device. In still another example, the method further includes while transmitting the secondary video stream, detecting an interruption in the second video stream; and based on detecting the interruption in the second video stream, transmitting, by the switching device, the primary video stream to the destination computing device instead of the secondary video stream.

In another example, switching from transmitting the primary video stream to transmitting the secondary video stream is performed in less than 100 milliseconds. In yet another example, the method further includes processing, by a first guard, the primary video stream prior to the primary video stream being received by the switching device; and processing, by a second guard, the secondary video stream prior to the secondary video stream being received by the switching device. In still another example, the transmitting device uses a transmit-only device, and the transmitting computing device does not receive data from the destination computing environment.

In another aspect, the technology relates to a system for video streaming in a one-way transfer (OWT) system. The system includes a transmitting computing device, located in a source computing environment, comprising a transmitter that transmits a video stream; a splitter that duplicates the video stream into a primary video stream and a secondary video stream; a first landing device, in a destination computing environment, that receives the primary video stream; a second landing device, in the destination computing environment, that receives the secondary video stream; and a switching device, in the destination computing environment, that performs operations including: receives the primary video stream and the secondary video stream; transmits the primary video stream to a destination computing device in the destination computing environment; detects at least one of an interruption or change of quality in the primary video stream; and based on detecting the at least one of the interruption or change of quality, transmits the secondary video stream to the destination computing device instead of the primary video stream.

In an example, the transmitting computing device uses a transmit-only device, and the transmitting computing device does not receive data from the first landing device or the second landing device. In another example, the beam splitter is a passive beam splitter. In yet another example, detecting the interruption in the primary video stream is based on continuity counter data for the video stream. In still another example, detecting the interruption in the primary video stream is based on performance data received from at least one of the first landing device of the second landing device. In still yet another example, a first guard that processes the primary video stream prior to being received by the first landing device; and a second guard that processes the secondary video stream prior to being received by the second landing device. In a further example, switching from transmitting the primary video stream to transmitting the secondary video stream is performed in less than 100 milliseconds.

In another aspect, the technology relates to a system for video streaming in a one-way transfer (OWT) system. The system includes a transmitting computing device, located in a source computing environment, comprising an optical transmitter that transmits optical signals corresponding to data transmitted by the transmitting computing device; a beam splitter that duplicates the video stream into a first duplicate video stream and a second duplicate video stream; a first landing device, located in a destination computing environment, that: receives the first duplicate video stream; generates first performance data about the first landing device; receives second performance data; and based on at least one of the first performance data or the second performance data, selectively drops or transmits the first duplicate video stream to a destination computing device of the destination computing environment. The system further includes a second landing device, located in the destination environment, that: receives the second duplicate video stream; generates the second performance data bout the second landing device; receives the first performance data; and based on at least one of the first performance data or the second performance data, selectively drops or transmits the second duplicate video stream to the destination computing device of the destination computing environment.

In an example, the first performance data and the second performance data includes continuity counter data. In another example, while the first landing device transmits the first duplicate video stream, the second landing device drops of the second duplicate video stream. In a further example, while the second landing device transmits the second duplicate video stream, the first landing device drops the first duplicate video stream.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for video streaming in a one-way transfer (OWT) system, the method comprising:
transmitting, by a transmitting device in a source computing environment, a video stream for receipt by a destination computing device in a destination computing environment;
forming a primary video stream and a secondary video stream by duplicating the video stream;
receiving, by a switching device in the destination computing environment, both the primary video stream and the secondary video stream;
transmitting, by the switching device, the primary video stream to the destination computing device without transmitting the secondary video stream;
detecting, by the switching device, an interruption or change of quality in the primary video stream; and
based on detecting the interruption or change of quality, transmitting, by the switching device, the secondary video stream to the destination computing device instead of the primary video stream.

2. The method of claim 1, wherein duplicating the video stream is achieved by splitting an optical signal representing the video stream.

3. The method of claim 1, wherein detecting the interruption in the primary video stream is based on continuity counter data for the video stream.

4. The method of claim 3, wherein the video stream is in a Moving Picture Experts Group (MPEG)-Transport Stream (TS) format.

5. The method of claim 1, further comprising:
receiving, by a first landing device in the destination computing environment, the primary video stream;
receiving, by a second landing device in the destination computing environment, the secondary video stream; and
wherein detecting the interruption in the primary video stream is based on performance data received from at least one of the first landing device or the second landing device.

6. The method of claim 1, further comprising:
while transmitting the secondary video stream, detecting an interruption in the second video stream; and
based on detecting the interruption in the second video stream, transmitting, by the switching device, the primary video stream to the destination computing device instead of the secondary video stream.

7. The method of claim 1, wherein switching from transmitting the primary video stream to transmitting the secondary video stream is performed in less than 100 milliseconds.

8. The method of claim 1, further comprising:
processing, by a first guard, the primary video stream prior to the primary video stream being received by the switching device; and
processing, by a second guard, the secondary video stream prior to the secondary video stream being received by the switching device.

9. The method of claim 1, wherein the transmitting device uses a transmit-only device, and the transmitting computing device does not receive data from the destination computing environment.

10. A system for video streaming in a one-way transfer (OWT) system, the system comprising:
a transmitting computing device, located in a source computing environment, comprising a transmitter that transmits a video stream;
a splitter that duplicates the video stream into a primary video stream and a secondary video stream;
a first landing device, in a destination computing environment, that receives the primary video stream;
a second landing device, in the destination computing environment, that receives the secondary video stream; and
a switching device, in the destination computing environment, that:
receives the primary video stream and the secondary video stream;
transmits the primary video stream to a destination computing device in the destination computing environment;
detects at least one of an interruption or change of quality in the primary video stream; and
based on detecting the at least one of the interruption or change of quality, transmits the secondary video stream to the destination computing device instead of the primary video stream.

11. The system of claim 10, wherein the transmitting computing device uses a transmit-only device, and the transmitting computing device does not receive data from the first landing device or the second landing device.

12. The system of claim 10, wherein the splitter is a passive beam splitter.

13. The system of claim 10, wherein detecting the interruption in the primary video stream is based on continuity counter data for the video stream.

14. The system of claim 10, wherein detecting the interruption in the primary video stream is based on performance data received from at least one of the first landing device of the second landing device.

15. The system of claim 10, further comprising:
a first guard that processes the primary video stream prior to being received by the first landing device; and
a second guard that processes the secondary video stream prior to being received by the second landing device.

16. The system of claim 10, wherein switching from transmitting the primary video stream to transmitting the secondary video stream is performed in less than 100 milliseconds.

17. A system for video streaming in a one-way transfer (OWT) system, the system comprising:
a transmitting computing device, located in a source computing environment, comprising an optical transmitter that transmits optical signals corresponding to a video stream transmitted by the transmitting computing device;
a beam splitter that duplicates the video stream into a first duplicate video stream and a second duplicate video stream;
a first landing device, located in a destination computing environment, that:
receives the first duplicate video stream;
generates first performance data about the first landing device;
receives second performance data; and
based on at least one of the first performance data or the second performance data, selectively drops or transmits the first duplicate video stream to a destination computing device of the destination computing environment; and
a second landing device, located in the destination computing environment, that:
receives the second duplicate video stream;
generates the second performance data bout the second landing device;
receives the first performance data; and
based on at least one of the first performance data or the second performance data, selectively drops or transmits the second duplicate video stream to the destination computing device of the destination computing environment.

18. The system of claim 17, wherein the first performance data and the second performance data includes continuity counter data.

19. The system of claim 17, wherein while the first landing device transmits the first duplicate video stream, the second landing device drops of the second duplicate video stream.

20. The system of claim 19, wherein while the second landing device transmits the second duplicate video stream, the first landing device drops the first duplicate video stream.
